(19) United States
(12) Patent Application Publication
(10) Pub. No.: US 2006/0195843 A1
(43) Pub. Date: Aug. 31, 2006

(54) Method and apparatus for scheduling maintenance and repair

(76) Inventor: Richard Gerry Hall, Hudson, FL (US)

Correspondence Address: LARSON AND LARSON, 11199 69TH STREET NORTH, LARGO, FL, 33773, US

(21) Appl. No.: 11/388,922

(22) Filed: Mar. 24, 2006

Related U.S. Application Data
(63) Continuation-in-part of application No. 11/067,416, filed on Feb. 25, 2005.

(51) Int. Cl. G06F 9/46

(52) U.S. Cl. 718/100

(57) ABSTRACT

A method and apparatus for scheduling an activity (calibration, repair, maintenance or upgrade of one or more instruments) is described, as well as scheduling an activity regarding an animate object. The method and apparatus includes a timer function that initiates a scan of a transaction database, looking for any transaction that is about to be due, is due or is past due, and upon finding such, initiates a pop-up message at the monitor of an operator that is associated with that transaction, so that the operator will know that they need to perform the associated activity on the associated instrument. Within the pop-up may be a link to directly access a calibration, repair, maintenance or upgrade procedure and possibly a link to a manual for the instrument. When the activity is complete, the operator enters completion information and the transaction record is time-stamped.

### PRIOR APPLICATIONS

This application is a continuation-in-part of U.S. patent application Ser. No. 11/067,416, filed on Feb. 25, 2005, now abandoned, which is incorporated herein by reference.

### FIELD OF THE INVENTION

This invention relates to a method and apparatus for scheduling the maintenance, care and repair of equipment or animate objects.

### BACKGROUND OF THE INVENTION

During use of high-tech laboratory equipment or the like, periodic calibration, maintenance, upgrades and repair are often required. For example, many multi-meters, oscilloscopes, waveform generators, voltage references and power supplies periodically require calibration to assure they are providing accurate outputs and measurements. In some laboratories, internal procedures are established to schedule such calibration several times within each year. Additionally, any equipment used in the manufacture or design of products under the ISO9000 certification are required to be calibrated under strict schedules and failing to do so may jeopardize re-certification with the ISO certification bodies. Other examples of equipment that needs regularly scheduled maintenance or testing are vehicles within a fleet (e.g., police cruisers), boats and special purpose engines such as used in portable applications to charge batteries in the field. Examples of animate objects that require periodic care includes livestock (e.g., vaccinations) and plants (e.g., watering, fertilizing and weed control application). Additionally, there is a need to schedule the use of equipment and provide usage reports for billing of that use. For example, universities have various equipment and resources that must be shared by a number of students such as supercomputers, spectrometers and temperature chambers.

Furthermore, when the numbers of such equipment rise and are spread around a company, perhaps in many different laboratories or are portable and may be transported among various laboratories, scheduling such calibration, maintenance, upgrades and repair becomes a very difficult task. Furthermore, manufacturers of equipment desire the users receive alerts regarding the manufacturer recommended maintenance and that the users adhere to these schedules that are required in the licensing of the equipment and by certifying and inspecting agencies.

What is needed is a computer-based system that will allow for scheduling of the calibration, scheduling, maintenance, upgrade and repair of each piece of equipment or animate object within a company, providing for assigning an operator to perform the activity and for tracking the completion of the activity in order to allow predictions of future activities. Furthermore, a way to track equipment is needed, whereby the cost of maintenance, availability and cost of supplies is tracked and can be reported over a specified period of time is needed.

### SUMMARY OF THE INVENTION

For the purposes of this application, and as seen in FIGS. 1-4 and FIG. 6, transactions will refer to one or more records stored in a transaction file, database or the like; containing information regarding an activity. The activity can be, for example, a calibration, maintenance, upgrade or repair event. Additionally, the activity can be related to the care of an animate object such as a person, crop, The activity can be, for example, watering or fertilizing plants or inoculating one or a group of livestock. Additionally, the activity can be, for example, scheduling and tracking of required employee training. Furthermore, the activity can be the scheduling of a resource such as the scheduling of equipment or a system. An operator is a person (or perhaps a robot) who will perform the activity.

An objective of the present invention is to provide a system that tracks activities that are performed on a routine basis, for example, calibrating an instrument, replacing a light bulb or inoculating an animal.

Another objective of the present invention is to provide a system that tracks a scheduling activity for a resource, for example, scheduling the use of a supercomputer by several students of a university.

Another objective of the present invention is to provide a system that correlates and operator (one who will perform the activity) with the activity such that it is clear who is to perform the activity and when.

Another objective of the present invention is to visually, electronically and/or audibly notify the operator of the upcoming activity, the currently required activity or the past due activity. Electronic notification includes, for example, email, paging and electronic messaging.

Another objective of the present invention is to collect completion records from the operator when the activity is complete.

Another objective of the present invention is to time stamp the completion records and corresponding reports to provide a legal description of when the activity was performed.

Another objective of the present invention is to time stamp the generated reports to provide evidence of when the activity was completed.

Another objective of the present invention is to provide reports by operator or by object (e.g., device, animal and field/pasture) showing the activity history (e.g., maintenance history).

In one embodiment, a system for scheduling an activity using a computer system is disclosed, in which a transaction file containing records, each record describing an activity is operated upon by a software module running on the computer system. The software module is configured to periodically scan the transaction file for an activity that is due to be performed, is about to be due to be performed or is past due to be performed and upon finding a transaction of this sort, the software module initiates a pop-up message on a monitor associated with the activity.

In another embodiment, a computer-implemented method for scheduling an activity is disclosed, including periodically scanning a set of transactions for an activity that is due or is about to be due or is past due and for each transaction that is about to be due, due or over due initiating a pop-up message at a monitor associated with that transaction. The pop-up message includes an indication, perhaps color coded, as to whether the transaction is about to be due, is due or is over due as well as a link to an on-line procedure associated with the transaction.

In another embodiment, a means for scheduling an activity is disclosed. Included is a means for creating and maintaining a set of transactions, then periodically scanning the set of transactions for transactions that are about to be due, are due, or are over due, then for transactions that are about to be due, are due or are over due: displaying a pop-up message. Also included is a mechanism for updating the transaction after an activity associated with the transaction is completed along with a time stamp.

In yet another embodiment, a computer-implemented method for scheduling an activity is disclosed, including providing a set of transactions, each transaction including at least an instrument identifier or object identifier, an operator identifier, an activity, an activity due date, an activity complete date and a link to a procedure, then periodically scanning the set of transactions for an active transaction that has an empty activity complete date and an activity due date that is due or is about to be due or is past due, then for each active transaction, initiating a pop-up message at a monitor associated with the operator listed on that transaction. The pop-up message indicates that the active transaction is about to be due, is due or is over due, possibly color coded, and also, optionally, includes a link to the procedure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a chart of the relations between the data structures of the present invention.

FIG. 2 illustrates a process flow diagram of the present invention.

FIG. 3 illustrates a sample transaction file of the present invention.

FIG. 4 is a schematic diagram of a timekeeper system according to the present invention.

FIG. 5 is a schematic diagram of a sample computer system according to the present invention.

FIG. 6 is a second chart of the relationships between the data structures of the present invention.

FIG. 7 is a typical report of the present invention.

FIG. 8 is a third chart of the relationships between the data structures of the present invention.

### DETAILED DESCRIPTION OF THE INVENTION

Reference will now be made in detail to the presently preferred embodiments of the invention, examples of which are illustrated in the accompanying drawings.

Throughout the following detailed description, the same reference numerals refer to the same elements in all figures. The term maintenance and activity are interchangeable, in that a scheduled maintenance event is analogous to a scheduled activity. For example, a scheduled maintenance event can be “feed a herd of cows” and a scheduled activity can be “change the oil in the emergency generator.”

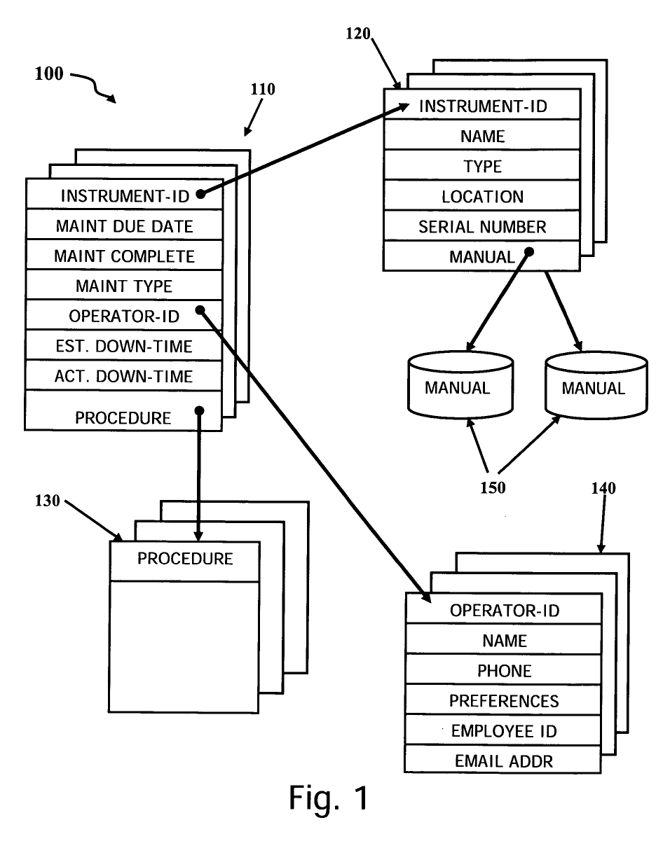

Referring to FIG. 1, a sample data structure or database 100 according to the present invention is shown. In this, there are task records 110 comprising an instrument-id to identify the instrument that is being scheduled, a maintenance due date, indicating when the activity should be performed, a maintenance complete date (to be filled in when the activity is complete), an operator-id (identifying who should perform the activity), an estimated down time and an actual down time (also filled in when the activity is complete). Linked to the task records 110 are instrument records 120 consisting of an instrument-id (linked to task records 110), a name (e.g., xyz-oscilloscope), a type (e.g., digital oscilloscope), a location (e.g., test lab), a serial number and a link to an on-line user manual. The instrument records may also include a link to a user manual 150 for the associated instrument. Also linked to the task records 110 are operator records 140 consisting of an operator-id (linked to task records 110), a name (e.g., Jane Smith), a phone number, a set of preferences (e.g., color preferences), an employee ID and an email address. Also linked to the task records 110 are a set of procedures 130, which can be used by the operator to complete the required activity.

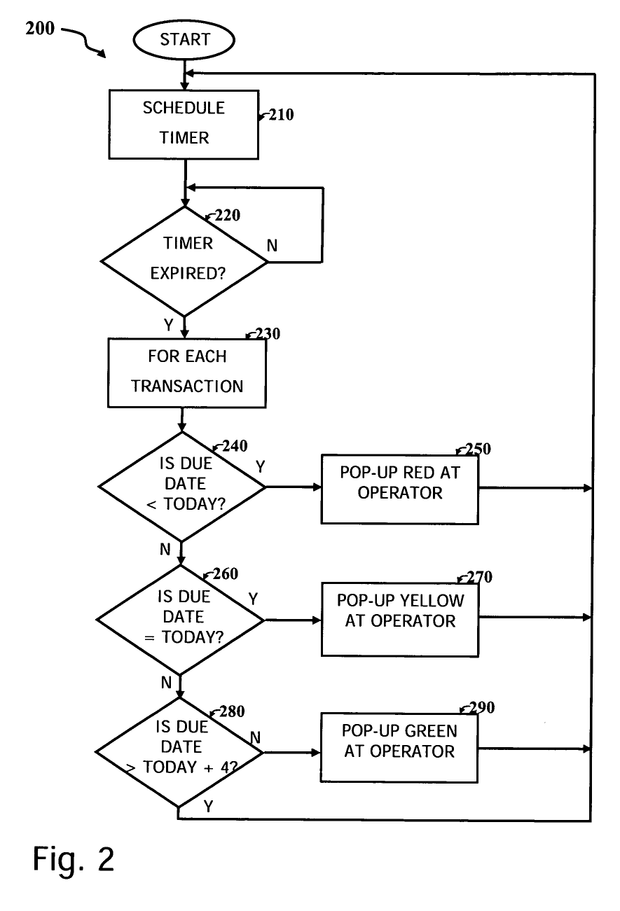

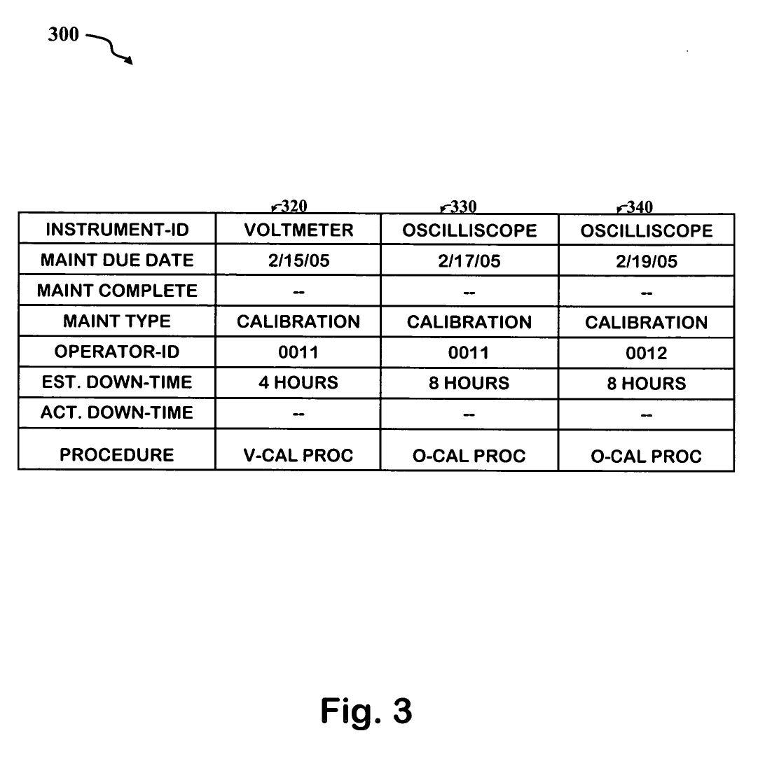

FIG. 2 shows a flow diagram 200 showing an embodiment of the timekeeper in operation. To understand how the timekeeper operates, FIG. 3 will be used as a sample set of task records 300. The timekeeper starts by scheduling a timer 210, then waiting for the timer to expire 220. Once the timer expires, each transaction in the set of task records 300 is checked to see if any are due 230. For this example, let us assume that the current date is Feb. 17, 2005. As the first record 320 is examined, its due date is less than today 240, so a pop-up message is displayed in red at operator 0011's monitor 250. As the second record 330 is examined, its due date is not less than today 240, but its due date is equal to today 260, so a pop-up message is displayed in yellow at operator 0011's computer 270. As the third record 340 is examined, its due date is not less than today 240 and its due date is not equal to today 260 but its due date is not greater than four days from today 280, so a pop-up message is displayed in green at operator 0012's computer 290. In this, a due date of Feb. 16, 2005, Feb. 17, 2005, Feb. 18, 2005 and Feb. 19, 2005 would all not be greater than four days from today, and therefore would pop-up green 290. If the records date was greater than four days from today, for example Feb. 20, 2005, no pop-up message would be displayed. Of course, any number of days could be used to determine when a transaction is soon to be due and there can be more than three tests, perhaps giving advanced notice at ten days, then again at four days.

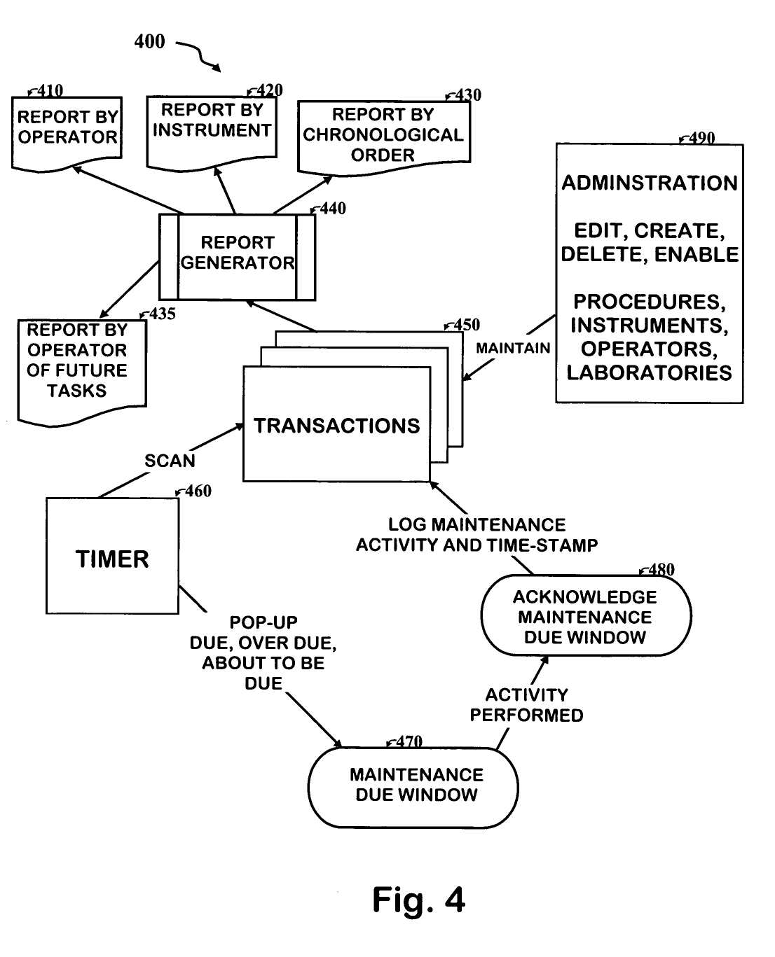

Referring to FIG. 4, a schematic block diagram of a timekeeper system 400 of the present invention is shown. Central to the timekeeper system is the transactions file or database 450. This file or database contains a record for each pending activity as well as completed activity for historical purposes. The administrative function 490 maintains the transactions 450, adding new records, deleting records, editing records, adding new procedures, manuals, operators and instruments, for example. The administrative function 490 may be used to add transaction records for unscheduled functions to track, for example, yearly maintenance costs, yearly disposables costs and yearly down-time. The report generator 440 can scan the transactions 450 and output various reports when needed, for example, reports by operator 410, reports by instrument 420, reports by chronological order 430 and reports of future (pending) tasks 435. The timer 460 periodically scans the transactions 450 looking for transactions that are due, about to be due or overdue and upon finding one or more, initiates one or more maintenance windows 470 at an operator's monitor to inform the operator that a transaction is due or almost due. Once the activity is complete, the operator acknowledges such, possibly entering details 480 such as elapsed time and parts needed at their monitor and the transaction is updated and time-stamped. The time stamp is generated from the computer's real-time-clock or other source of reliable time (e.g., Global Positioning Satellite or Cell Phone Network) and is stored in the transaction. The time-stamp cannot be externally modified, thereby providing hard evidence of the date and time that the completion of the activity was recorded.

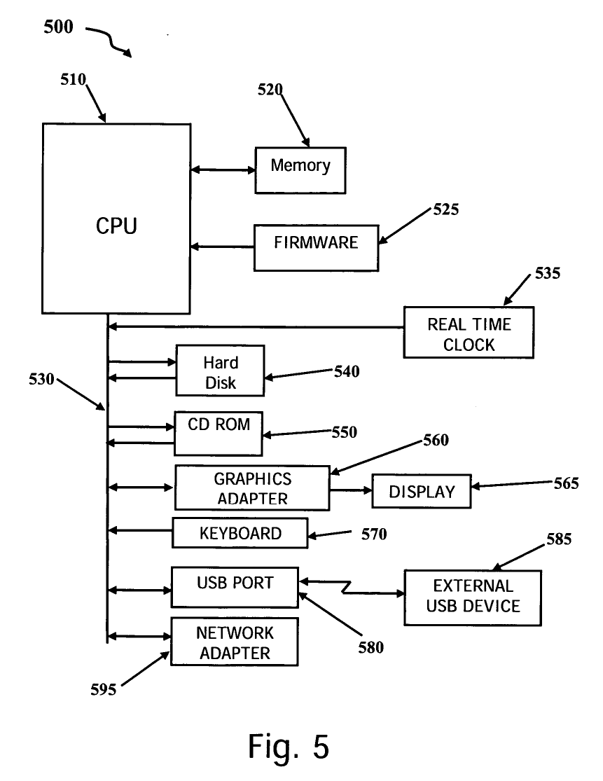

Referring to FIG. 5, a schematic block diagram of a computer-based system 500 of the present invention is shown. In this, a processor 510 is provided to execute stored programs that are generally stored within a memory 520. The processor 510 can be any processor, perhaps an Intel Pentium-5® CPU or the like. The memory 520 is connected to the processor and can be any memory suitable for connection with the selected processor 510, such as SRAM, DRAM, SDRAM, RDRAM, DDR, DDR-2, etc. The firmware 525 is possibly a read-only memory that is connected to the processor 510 and may contain initialization software, sometimes known as BIOS. This initialization software usually operates when power is applied to the system or when the system is reset. Sometimes, the software is read and executed directly from the firmware 525. Alternately, the initialization software may be copied into the memory 520 and executed from the memory 520 to improve performance.

Also connected to the processor 510 is a system bus 530 for connecting to peripheral subsystems such as a real time clock 535, a hard disk 540, a CDROM 550, a graphics adapter 560, a Universal Serial Bus (USB) port 580, a keyboard 570 and a network adapter 595. The graphics adapter 560 receives commands and display information from the system bus 530 and generates a display image that is displayed on the display 565.

In general, the hard disk 540 may be used to store programs, executable code and data persistently, while the CDROM 540 may be used to load the programs, executable code and data from removable media onto the hard disk 540. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 530 or with other input-output functions. Examples of these devices include printers; mice; graphics tablets; joysticks; and communications adapters such as modems and Ethernet adapters.

In some embodiments, the USB port 580 may be connected to an external USB device 585. The example shown has an external USB device 585 which may be a flash drive, memory card, external hard drive, keyboard or mouse, for example.

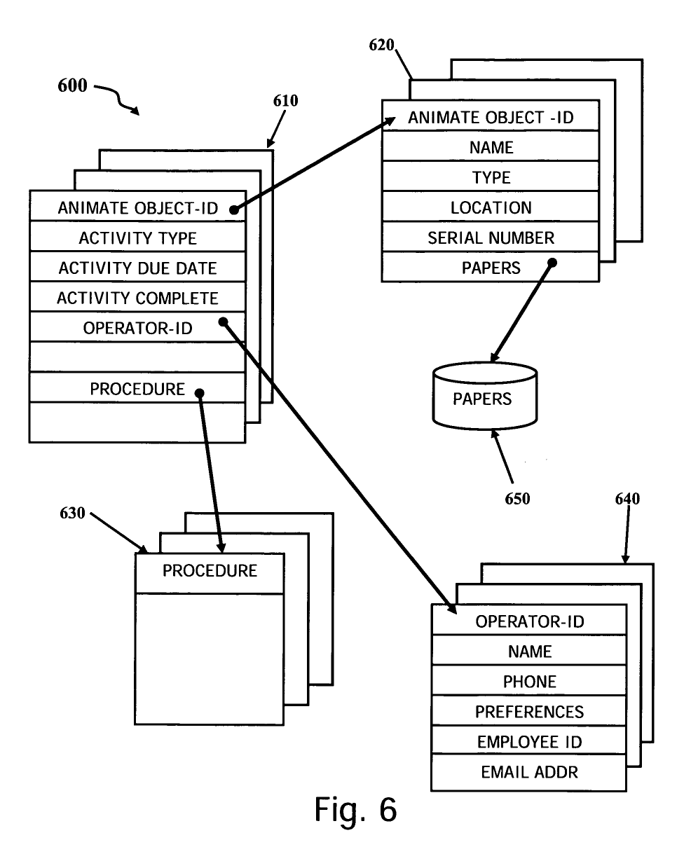

Referring to FIG. 6, a second sample data structure or database 600 according to the present invention is shown. In this, there are task records 610 comprising an animate-object-id to identify the animal, plant, group of animals or group of plants that is being scheduled, an activity type (for example, inoculate animal or fertilize a specified field), an activity due date, indicating when the activity should be performed, an activity complete date (to be filled in when the activity is complete), an operator-id (identifying who should perform the activity) and an email address (email addr). Linked to the task records 610 are animate object records 620 consisting of an animate-object-id (linked to task records 110), a name (e.g., Betsy), a type (e.g., Holstein), a location (e.g., barn), a serial number and a link to additional records 650 related to the plant or animal (e.g., pedigree papers). Also linked to the task records 610 are operator records 640 consisting of an operator-id (linked to task records 610), a name (e.g., Jane Smith), a phone number, a set of preferences (e.g., color preferences) and an employee ID. Also linked to the task records 610 are a set of procedures 630, which can be used by the operator to complete the required activity (e.g., instructions regarding how much food to provide).

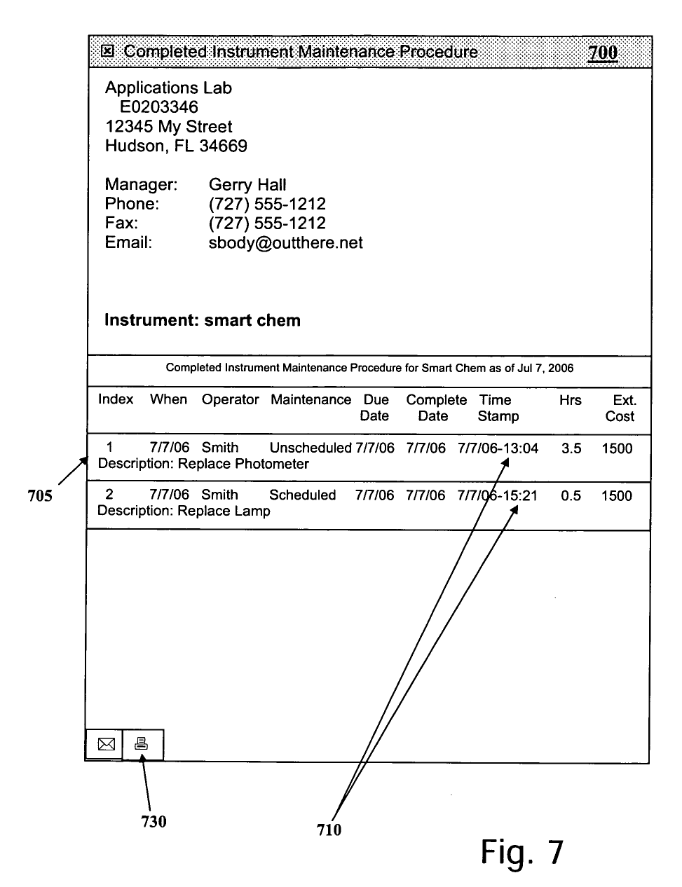

Referring to FIG. 7, a typical report 700 of the present invention is shown. The report 700 shows four activities performed by one particular operator. The first activity 705 was for unscheduled maintenance, replacing a photometer. The activity was completed and time-stamped 710 on Jul. 7, 2005. A print function 730 is available to print the report, creating a hard copy including the time stamp.

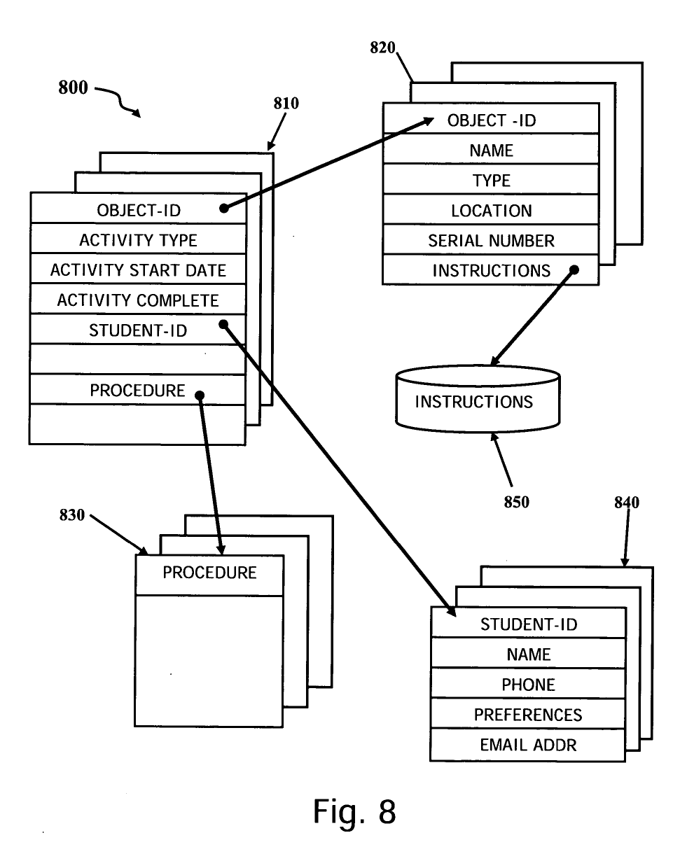

Referring to FIG. 8, a third sample data structure or database 800 according to the present invention is shown. In this, there are task/scheduling records 810 comprising an object-id to identify the resource that is being scheduled (e.g., a supercomputer or test equipment within a corporation or a university), an activity type (for example, run gene splitting simulation), an activity start date, indicating the start of when the resource is to be used, an activity complete date indicating when the equipment will be free for others to use and an student-id (or employee) (identifying who should perform the activity). Linked to the task records 810 are resource records 820 consisting of an object-id (linked to task records 110), a name (e.g., HAL 2001 Supercomputer), a type (e.g., HAL), a location (e.g., Computer Science Laboratory), a serial number and a link to additional records 850 related to the operation (e.g., programming manual). Also linked to the task records 810 are student/employee records 840 consisting of a student-id (or employee-id) (linked to task records 810), a name (e.g., Jane Smith), a phone number, a set of preferences (e.g., color preferences), a student or employee ID and an email address (email addr). Also linked to the task records 810 are a set of procedures 830, which can be used by the operator to complete the required activity (e.g., instructions regarding how to start the resource and what state to leave the resource when finished).

Although the present invention has been described in relation to particular embodiments thereof, many other variations and modifications and other uses will become apparent to those skilled in the art. It is preferred, therefore, that the present invention be limited not by the specific disclosure herein, but only by the appended claims. Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system scheduling an activity comprising:
a computer system;
a transaction file stored on a storage media, the storage media operatively coupled to the computer system, the transaction file containing records, each of the records describing an activity; and
a software module running on the computer system and configured to periodically scan the transaction file for an activity that is due to be performed or an activity that is about to be due to be performed or an activity that is over due to be performed;
whereas the software module initiates a pop-up message on a monitor associated with the activity if the activity that is due, is about to be due or is over due.

2. The system of claim 1, whereas the activity is selected from a group consisting of calibration, maintenance, upgrade and repair.

3. The system of claim 1, whereas the activity is the scheduling of a resource.

4. The-system of claim 1, whereas the activity is selected from a group consisting of feeding, fertilizing, inoculating and watering.

5. The system of claim 1, whereas the records contain at least an instrument-id, an operator-id and a due-date.

6. The system of claim 5, whereas the records also contain a link to a procedure.

7. The system of claim 6, whereas the pop-up message includes an active link to the procedure.

8. The system of claim 7, whereas the pop-up message is color coded with a unique color for each of the activity that is due, the activity that is about to be due and the activity that is over due.

9. The system of claim 1, further comprising a report generator application configured to scan the records and configured to generate reports on past activities and configured to generate reports on future activities.

10. The system of claim 9, whereas the report generator includes a time stamp on the reports.

11. A computer-implemented method for scheduling an activity comprising:
periodically scanning by the computer a set of transactions for an activity that is due or is about to be due or is past due;
for each transaction that is about to be due, due or over due:
initiating a pop-up message at a monitor associated with the each transaction, the pop-up message indicating that the each transaction is about to be due, is due or is over due; and
providing a link within the pop-up message to an on-line procedure associated with the each transaction.

12. The method of claim 11, further comprising a step of accepting an acknowledgement indicating that the activity is complete and marking the transaction as complete.

13. The method of claim 12, further comprising a step of adding a time stamp to the transaction indicating the time that the step of accepting the acknowledgement was performed.

14. The method of claim 11, whereas the pop-up message is color coded, a first color if the transaction is about to be due, a second color if the transaction is due and a third color if the transaction is over due.

15. The method of claim 14, whereas the first color is green and the second color is yellow and the third color is red.

16. The method of claim 11, whereas the activity is selected from a group consisting of calibration, maintenance, upgrade and repair.

17. The method of claim 11, whereas the link is provided within the pop-up message.

18. A means for scheduling an activity comprising:
a means for creating and maintaining a set of transactions;
a means for periodically scanning the set of transactions for individual transactions that are about to be due, are due, or are over due;
a means for initiating a pop-up message on a monitor associated with the individual transactions that are about to be due, are due or are over due; and
a means for updating the individual transaction after an activity associated with the individual transaction has been completed.

19. The means of claim 18, whereas the activity is selected from a group consisting of calibration, maintenance, upgrade and repair.

20. The means of claim 18, further comprising a means to generate reports from the set of transactions.

21. The means of claim 18, further comprising a means to add a time stamp to the individual transaction by the means for updating.

22. A computer-implemented method for scheduling an activity comprising:
providing a set of transactions, each individual transaction within the set of transactions including at least an instrument identifier, an operator identifier, an activity, an activity due date, an activity complete date and a link to a procedure;
periodically scanning the set of transactions for one or more active transactions that has an empty activity complete date and an activity due date that is due or is about to be due or is past due; and
for each of the active transactions:
initiating a pop-up message at a monitor associated with the operator identifier of the active transaction, the pop-up message indicating that the active transaction is about to be due, is due or is over due, the pop-up message also including a displayed link to the procedure.

23. The method of claim 22, whereas the activity is selected from a group consisting of calibration, maintenance, upgrade and repair.

24. The method of claim 22, further comprising generating reports from the set of transactions.

25. The method of claim 22, whereas the activity is about to be due if the activity due date is less than four days from the current date.
